(19) United States
(12) Patent Application Publication
(10) Pub. No.: US 2006/0012148 A1
(43) Pub. Date: Jan. 19, 2006

(54) Wheelchair having a leg rest assembly

(76) Inventors: Mauricio Melgarejo, Simi Valley, CA (US); Alejandro Melgarejo, Simi Valley, CA (US)

Correspondence Address: CALFEE HALTER & GRISWOLD, LLP, 800 SUPERIOR AVENUE, SUITE 1400, CLEVELAND, OH, 44114, US

(21) Appl. No.: 11/180,773

(22) Filed: Jul. 13, 2005

Related U.S. Application Data
(60) Provisional application No. 60/587,784, filed on Jul. 14, 2004.

(51) Int. Cl. A61G 5/10

(52) U.S. Cl. 280/304.1

(57) ABSTRACT

A leg rest assembly includes an elevating member for supporting a user's leg, which is adapted to move in a first and second direction. The leg rest assembly also includes a mechanism that can be selectively engaged and disengaged. The elevating member is adapted to freely move in the first direction and is prevented from moving in the second direction when the mechanism is engaged, and is adapted to freely move in both the first and second directions when the mechanism is disengaged.

### RELATED APPLICATION

This application claims the benefit of U.S. Provisional Application No. 60/587,784 filed Jul. 14, 2004, the entire disclosure of which is hereby incorporated by reference.

### BACKGROUND OF THE INVENTION

The present invention relates in general to a wheelchair and, in particular, to a leg rest assembly that may be used on a wheelchair.

Wheelchairs are often provided with leg rests or foot rests upon which a user may place his or her legs. The leg rests may be adjustable so that the leg rests may be raised or lowered. The mechanisms for providing leg rest adjustment are often bulky and may interfere with patient movement. Additionally, the mechanisms may require that a user lift his or her legs so that the leg rest may be lowered.

### SUMMARY

In one embodiment, a leg rest assembly includes an elevating member for supporting a user's leg, which is adapted to move in a first and second direction. The leg rest assembly also includes a mechanism that can be selectively engaged and disengaged with the elevating member. The elevating member is adapted to move freely in a first direction and be prevented from pivoting in a second direction when the mechanism is engaged with the elevating member. The elevating member is adapted to move freely in both the first and second directions when the mechanism is disengaged from the elevating member.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 is an exploded perspective view of a leg rest assembly according to one embodiment of the present invention;

FIGS. 2A-2C are perspective views of one embodiment of a leg rest assembly in lowered, raised, and partially raised positions;

FIG. 3 is a cross-sectional view of one embodiment of a leg rest assembly;

FIG. 4 is a perspective view of one embodiment of a leg rest assembly having a leg rest platform for support of a user's leg;

FIG. 5 is a perspective view of one embodiment of a wheelchair having leg rest assemblies;

FIG. 6 is a perspective view of one embodiment of a leg rest assembly having a securing member; and

FIG. 7 is a perspective view of a portion of the leg rest assembly of FIG. 6.

### DETAILED DESCRIPTION OF EMBODIMENTS OF THE PRESENT INVENTION

The present invention will now be described with reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

The present invention relates to leg rest assemblies. In particular, the present invention relates to leg rest assemblies that may be used on wheelchairs. The present invention also relates to wheelchairs having leg rest assemblies. The leg rest assemblies may allow free movement of a portion or portions of the assemblies in a first direction and selective movement of portions or portions of the assemblies in a second direction.

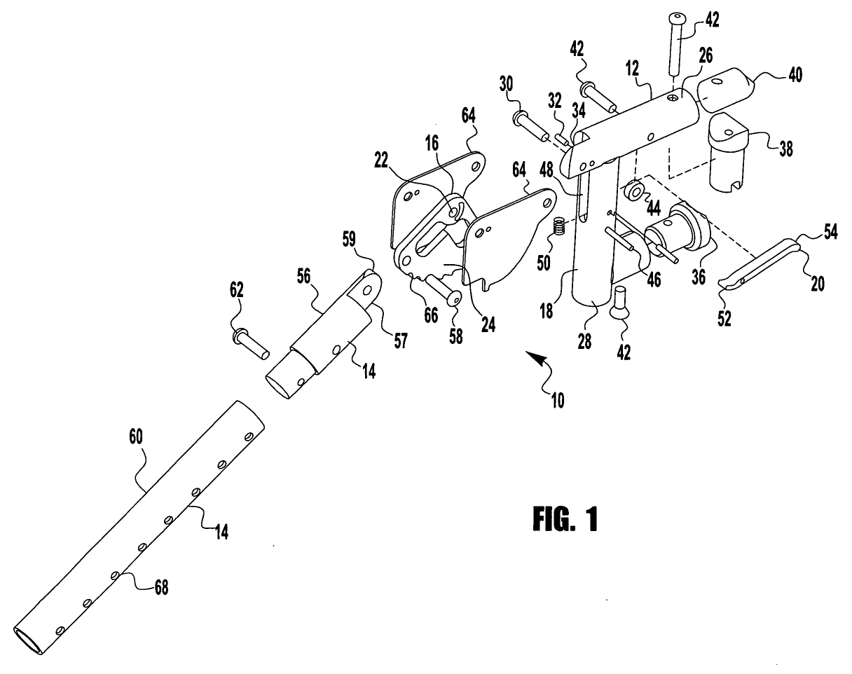

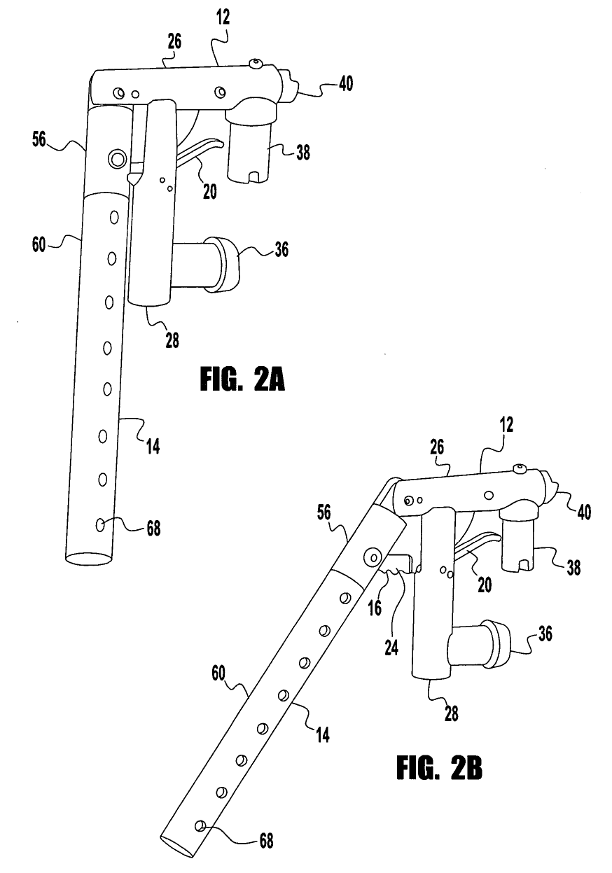

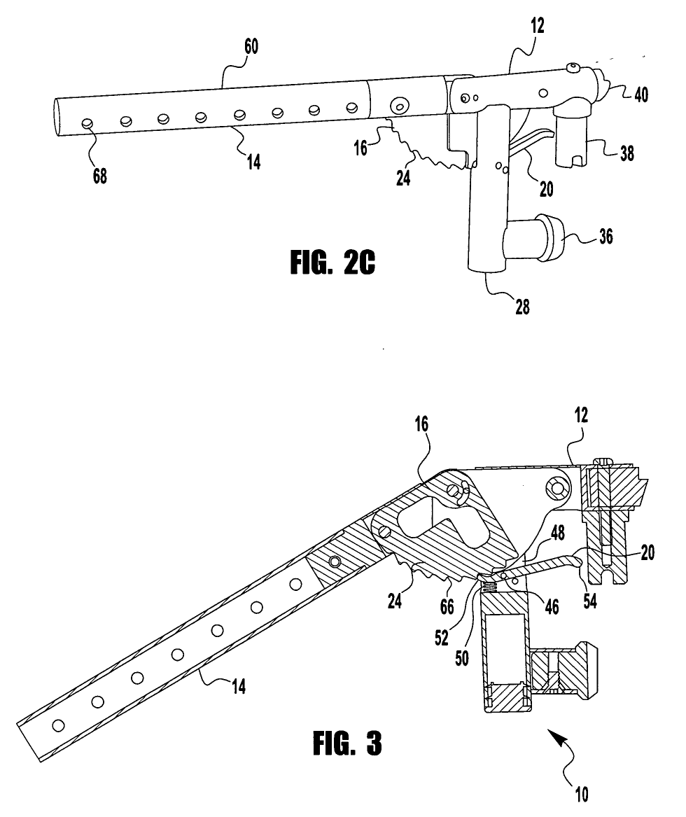

Referring to FIGS. 1 and 2A-2C, a leg rest assembly 10 is illustrated. The assembly 10 includes a hanger member 12, an elevating member 14, and a pivoting member 16. The hanger member 12 has a hanger portion 18 and a lever 20. The pivoting member 16 has a pivoting point 22 and an arcuate portion 24. The arcuate portion 24 of the pivoting member 16 may be an arched area that is centered on the pivoting point 22. The pivoting member 16 may be formed in any suitable manner to allow the elevating member 14 to be raised and lowered. The hanger member 12 and the elevating member 14 are attached to the pivoting member 16. The lever 20 is disposed to variably engage or disengage the arcuate portion 24 of the pivoting member 16. The pivoting member 16 may be pivoted about the pivoting point 22 in a first direction or a second direction to allow the elevating member 14 to be selectively raised or lowered. The pivoting member 16 may be freely pivoted in the first direction to raise the elevating member 14. The pivoting member 16 may be pivoted in the second direction when the lever 20 is disengaged from the arcuate portion 24.

The hanger portion 18 may have an upper portion 26 and a lower portion 28, and the upper portion 26 and the lower portion 28 may be disposed to form a T shape. The pivoting member 16 is attached to the hanger portion. In the embodiment illustrated in FIG. 1, the hanger portion is attached to the upper portion 26 of the hanger portion 18. The hanger portion 18 may be attached to the pivoting member 16 at the pivoting point 22 in any suitable manner. For example, as shown in FIG. 1, a screw 30 and a dowel pin 32 may be used to attach the upper portion 26 of the hanger portion 18 to the pivoting member 16 such that the pivoting member 16 may pivot about the pivoting point 22. The dowel pin 32 may be used to ensure that the pivoting member 16 may only pivot through a desired number of positions or degrees. The upper portion 26 of the hanger portion 18 may have a notch or recess 34 that reduces the amount of space that the pivoting member 16 must occupy outside of the hanger member 12.

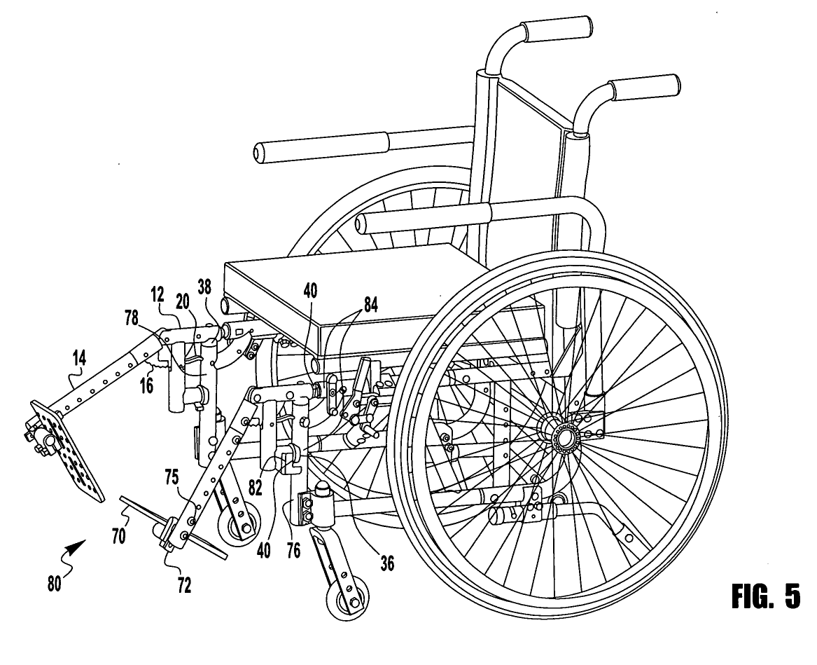

The hanger portion 18 may be provided with any suitable attachment parts so that the hanger portion 18 may be mounted to the frame of a wheelchair (see FIG. 5). For example, the hanger portion 18 may also have a hanger guide 36 that aligns the hanger member 12 with a wheelchair frame. Additionally, the hanger portion 18 may have a hanger pivot bushing 38 that may be placed in a vertical tubular member on a wheelchair frame to provide a vertical pivot axis for the leg rest assembly 10. The hanger portion 18 may also have a hanger latch 40 that may be used to latch the hanger member 12 to a wheelchair frame. The attachment parts may be provided in any suitable manner and may be attached in any suitable way. For example, screws 42 and a spacer 44 may be used to attach the hanger guide 36, hanger pivot bushing 38, and the hanger latch 40, as shown in FIG. 1.

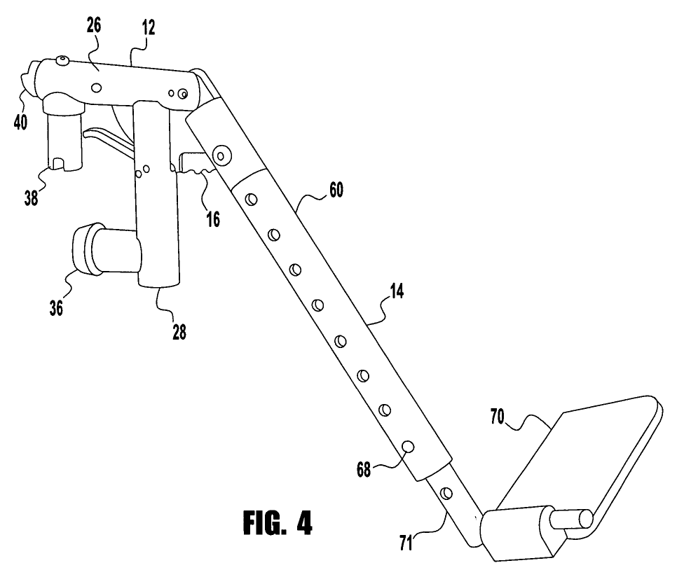

Referring now to FIGS. 2A-2C and 3, the lower portion 28 of the hanger portion 18 may have an opening 48 disposed such that the arcuate portion 24 of the pivoting member 16 may pass through the lower portion when the pivoting member pivots. The lever 20 may be attached to the hanger portion 18 in any suitable manner. For example, the lever 20 may be attached to the lower portion 28 of the hanger portion 18 by a dowel 46 that allows the lever to be moved as desired. The lever 20 may be disposed such that the lever 20 positively engages the arcuate portion 24 of the pivoting member 16 unless the lever 20 is disengaged as shown in FIG. 3. For example, a compression spring 50 may be provided below a first end 52 of the lever 20 such that a constant engagement force is provided to the lever 20 such that the first end 52 of the lever is in engagement with the arcuate portion 24. The opening 48 may have a notch or seat in which a portion of the compression spring 50 may be seated so that the spring 50 does not come loose from the hanger portion 18. Alternatively, the compression spring 50 can be attached to the inside of the opening 48 or in any other suitable manner.

The lever 20 may be disengaged from the arcuate portion 24 by providing pressure on a second end 54 of the lever to compress the spring 50 and release the first end 52 of the lever 20 from the arcuate portion 24. For example, upward pressure on the second end 54 of the lever 20 may be used to disengage the lever 20 from the arcuate portion 24.

In another example, the second end 54 of the lever 20 can be made to be very heavy so that gravity provides an engagement force to keep the first end 52 of the lever 20 in engagement with the arcuate portion 24. In another example, the pivoting member 16 can be a ratchet like-mechanism. The ratchet like mechanism can be operated in conjunction with the lever 20 or the lever 20 can be replaced with a ratcheting control. It should be apparent to one skilled in the art that the structure and configuration of the lever 20 could vary greatly and the shape and configuration of the lever is not limited as described herein. In addition, it should also be apparent to one skilled in the art that the lever 20 of the leg rest assembly could be replaced by other various mechanisms that are capable of engaging and disengaging with the pivoting member 16. For instance, the lever 20 could be replaced by a push-button, sliding tab or other mechanism capable of positively engaging with the pivoting member 16, thus securing it in place, until the mechanism is intentionally disengaged.

The pivoting member 16 may have a guard or guards 64 disposed to protect the pivoting member 16 from intrusion of foreign matter and for the safety of the user. Referring now to FIGS. 2A-2C, the pivoting member 16 may be disposed to pivot in any suitable manner. For example, the pivoting member 16 may pivot from 90° to 180° or more. In another example, the pivoting member 16 may be disposed to pivot from 90° to 180° or less. As shown in FIG. 2A, the elevating member 14 may be in a lowered position such that the elevating member is at 90° with respect to the upper portion 26 of the hanger member 12. The elevating member 14 may then be moved freely in a first or upward direction as shown in FIG. 2B such that the elevating portion 14 is in a partially raised position. The elevating member 14 may subsequently be moved to a fully raised position as shown in FIG. 2C such that the elevating member 14 is at 180° with respect to the upper portion 26 of the hanger member 18. The elevating member 14 may be lowered to the position shown in FIG. 2A at any time by disengaging the lever 20 from the arcuate portion 24 of the pivoting member 16.

The arcuate portion 24 may have a notch or notches 66 provided thereon and disposed such that the second end 52 of the lever 20 may prevent the pivoting member from pivoting in a second or downward direction while the lever 20 is engaged. For example, the second end of the lever 52 may be engaged in a notch 66 such that the elevating member 14 is in a partially raised position as shown in FIG. 3, and the elevating member 14 may be returned to a lowered position as shown in FIG. 2A by providing upward pressure on the second end 54 of the lever 20 such that the first end 52 of the lever is disengaged from the notch 66. The notches 66 are disposed such that the pivoting member 16 may pivot freely in a first or upward direction but not in a second or downward direction while the lever 20 is engaged. When the lever 120 is disengaged from the pivoting member 16, the pivoting member is free to move in either an upward or downward direction. The arcuate portion 24 may be provided with any suitable number of notches 66. For example, the arcuate portion 24 may have a notch 66 every 10°. However, a larger number or smaller number of notches 66 may be provided. Alternatively, the arcuate portion 24 be a smooth surface disposed so that the lever 20 may engage the arcuate portion 24 by frictional or clamping engagement.

The elevating member 14 may have a hinge portion 56 attached to the pivoting member 16 by a screw 58 or in any other suitable manner. The hinge portion 56 may be attached to an area proximate the arcuate portion 24 as shown in FIGS. 1 and 2. The hinge portion 56 has an end 59 that may be proximate to the upper portion 26 of the hanger member 12 when the leg rest assembly 10 is assembled as shown in FIG. 2. The elevating member could also be formed together with the pivoting member 16 in a one-piece construction.

The hinge portion 56 may have a notch or recess 57 provided to accommodate the pivoting member 16. The notch or recess 57 reduces the amount of space that the pivoting member 16 must occupy in the assembly. The elevating member 14 may further have a tube 60 attached to the hinge portion 56. While the elevating member 14 and other portions of the leg rest assembly 10 are illustrated as tubular shaped pieces in the illustrated embodiment, it should be apparent that the elevating member and other portions of the leg rest assembly could be constructed from pieces with cross-sections of various shapes such as rectangular or oval.

The tube 60 may be attached to the hinge portion 56 in any suitable manner. For example, the tube 60 may be attached to the hinge portion 56 by a screw 62 as shown. The tube 60 and the hinge portion 56 may be moved in a first or upward and a second or downward direction during the operation of the assembly. The tube 60 may have holes 68 provided therein so that a leg rest, pad, or any other desired assembly may be provided on the tube 60. The elevating member 14 could be made from one piece or could be of multi-piece construction. Furthermore, if the elevating member 14 includes a hinge portion 56 and a tube 60, these pieces could also each be provided as a one piece, two piece, or three or more piece assembly as desired.

The components of the assembly 10 may be made from any suitable material. For example, the hanger member 12, elevating member 14, and pivoting member 16 can be made from aluminum. In another example, the hanger member 12, elevating member 14, and pivoting member 16 can be made from any suitable plastic, steel, stainless steel, or alloy or composite. The present invention is not intended to be limited by the type of materials used to construct the assembly 10.

The operation of the assembly 10 will now be discussed further with reference to FIGS. 1, 2A-2C and 3. As shown in FIG. 3, the notches 66 in the arcuate portion 24 of the pivoting member 16 are designed to allow the arcuate portion 24 of the pivoting member 16 to urge the end portion 52 of the lever 20 downward in a ratcheting manner while pivoting in a first direction, thus allowing the elevating member 14 attached to the pivoting member to move freely in the first or upward direction. The notches 66, however, are shaped to engage with the end portion 52 of the lever when the pivoting member attempts to pivot in a second direction, thus securely locking into position with the lever 20 and preventing the pivoting member from pivoting in the second direction. This prevents the elevating member 14 from moving in the second or downward position.

The elevating member 14 may be raised or elevated to the desired position easily without applying pressure to the lever 20. For example, the elevating member 14 can be raised to the positions illustrated in FIGS. 2B and 2C or to any other desired position. Once the elevating member 14 is in the desired position, the lever 20 indexes into a corresponding notch 66 on the pivoting member 16 as shown in FIG. 3. The positive engagement between the lever 20 and the pivoting member 16 constrains the elevating member 14 from moving downward out of the desired position. Upward pressure on the lever 20 disengages the lever 20 from the corresponding notch 66 in the pivoting member 16 allowing the elevating member 14 to return to the full downward position as shown in FIG. 2A. The assembly 10 would operate similarly if the pivoting member 16 did not have notches 66. The elevating member 14 may be returned to the full downward position illustrated in FIG. 2A while the leg of a patient rests on the elevating member 14, simply by releasing the lever 20.

As shown in FIG. 4, the leg rest assembly 10 may have any suitable leg rest hardware attached thereto. For example, as shown in FIG. 4, a leg rest platform 70 may be provided by inserting a tube 71 having a leg rest platform 70 attached, into the elevating member 14, and securing the tube as needed. FIG. 5 shows an alternative attachment means the leg rest platform 70 is shown. The leg rest platform 70 may be attached to a bar 72 that is screwed to one or more of the openings 68 in the elevating member 14 by a screw 75.

The leg rest assembly 10 may be attached to the frame 76 of a wheelchair 80 in any suitable manner. For example, as shown in FIG. 5, the hanger pivot bushing 38 may be inserted into a tube 78 of the wheelchair frame 76. The hanger guide 36 may be placed into a hanger guide receiving portion 82 of the wheelchair frame 76, and the hanger latch 40 may be latched to a hanger latch portion 84 on the wheelchair frame 76.

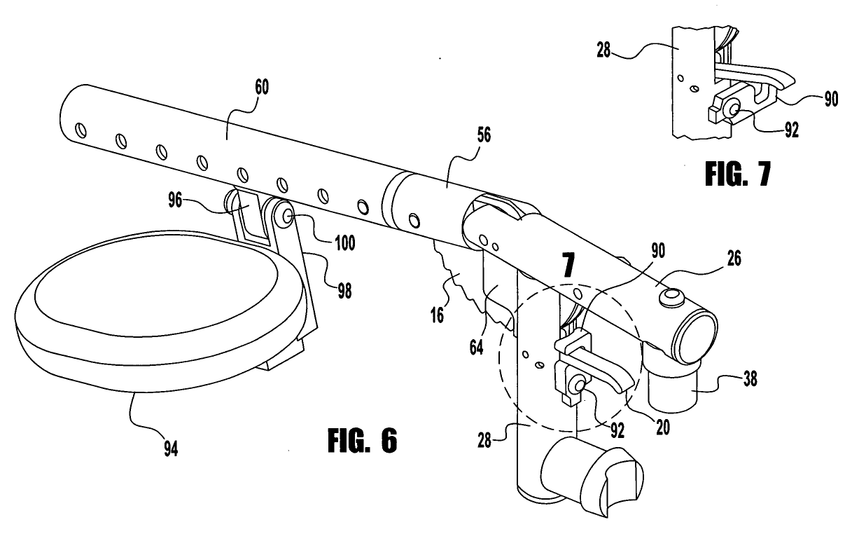

As shown in FIG. 6, the leg rest assembly 10 may also include a securing member or lock 90, which engages with the lever 20. In the embodiment shown in FIG. 6, the securing member 90 has a hook like shape and is attached to the lower portion 28 of the hanger portion 18 by a fastener 92. The securing member 90 of the embodiment shown in FIG. 6 is adapted to pivot between a first position in which it is engaged with the lever 20, as shown in FIG. 6, and a second position in which it is disengaged from the lever 20, as shown in FIG. 7. When the securing member 90 is engaged with the lever 20, it secures the lever in place and prevents the lever from moving upward or downward. When the lever 20 is thus secured, the pivoting member 16 is prevented from moving in both the first or upward direction and the second or downward direction. Accordingly, once a user has moved the elevating member 14 of the leg rest assembly 10 to its desired height, the user may then engage the securing member 90 with the lever 20 to prevent any subsequent movement of the elevating member 14. The securing member 90 also prevents any accidental disengagement of the lever 20, thus preventing undesired movement of the elevating member 14. This securing member 90 need not be included with all embodiments of leg rest assembly 10.

Referring once again to FIG. 6, the leg rest assembly 10 may include a leg pad 94 for the support of a user's leg. The leg pad shown in the embodiment in FIG. 6 includes an attachment frame 96 which is mounted to the tube 60 of the elevating member 14. The attachment frame 96 is adapted to be moved along the tube 60 to allow the location of the leg pad 94 to be chosen by the user according to comfort ability and support. In the embodiment shown in FIG. 6, the leg pad 94 is mounted to the attachment frame 96 by support bracket 98 and fastener 100. This arrangement allows the leg pad 94 to also be rotated with respect of the attachment frame 96 to adjust the leg pad according to the user's preference. The leg rest assembly 10 could include various combinations and numbers of leg pads 94 and leg rest platforms 70. In addition, the shape and configuration of both the leg pad 94 and leg rest platform 70 could vary greatly and they could be attached to the leg rest assembly in various ways.

Finally, it will be obvious to those skilled in the art that various changes may be made without departing from the scope of the invention, which is not to be considered limited to what is described in the specification.

1. A leg rest assembly such as for a wheel chair, comprising:
an elevating member that can support a leg;
said elevating member being adapted to pivot in a first direction and a second direction; and
a device that can be selectively engaged and disengaged so that said elevating member can freely pivot in said first direction and is prevented from pivoting in said second direction when said device is engaged, and said elevating member can pivot in said first direction and in said second direction when said device is disengaged.

2. The assembly as claimed in claim 1 wherein said device comprises a pivoting member and a lever.

3. The assembly as claimed in claim 2, wherein:
said pivoting member comprises a pivoting point and an arcuate portion and may be pivoted in a first direction and a second direction about the pivoting point;
said elevating member connected with said pivoting member for pivotal movement therewith;
said lever is disposed to selectively engage and disengage said arcuate portion of said pivoting member; and
said pivoting member may be freely pivoted in said first direction when the lever is engaged or disengaged with said arcuate portion of said pivoting member, and said pivoting member may be pivoted in said second direction only when said lever is disengaged from said arcuate portion of said pivoting member.

4. The assembly as claimed in claim 3 wherein said lever is disposed to positively engage said arcuate portion of said pivoting member by pressure provided by a compression spring, and wherein said lever may be disengaged from said arcuate portion of said pivoting member by providing pressure to said lever to compress said compression spring.

5. A leg rest assembly as set forth in claim 1 wherein said device is a lever and ratchet mechanism.

6. An assembly, comprising:
a hanger member comprising a hanger portion and a lever;
an elevating member; and
a pivoting member comprising a pivoting point and an arcuate portion, wherein:
said hanger member and said elevating member are attached to said pivoting member;
said lever is disposed to variably engage and disengage said arcuate portion of said pivoting member;
said pivoting member may be pivoted in a first direction and a second direction such that said elevating member is raised or lowered;
said pivoting member may be freely pivoted in said first direction when the lever is engaged or disengaged from said arcuate portion of said pivoting member; and
said pivoting member may be pivoted in said second direction only when said lever is disengaged from said arcuate portion of said pivoting member.

7. The assembly as claimed in claim 6 wherein said hanger member is attached to said pivoting member at said pivoting point.

8. The assembly as claimed in claim 7 wherein said elevating member is attached to said pivoting member proximate to said arcuate portion of said pivoting member.

9. The assembly as claimed in claim 8 wherein:
said elevating member has an end attached to said pivoting member;
said hanger member has an upper portion attached to said pivoting member;
said end of said elevating member is proximate to said upper portion of said hanger member.

10. The assembly as claimed in claim 9 wherein said hanger member has a lower portion disposed such that said arcuate portion of said pivoting member may pass through said lower portion of said hanger member, and wherein said lever is attached to said lower portion of said hanger member.

11. The assembly as claimed in claim 6 wherein said lever positively engages said arcuate portion of said pivoting member by pressure provided by a compression spring, and wherein said lever may be disengaged from said arcuate portion of said pivoting member by providing pressure to said lever to compress said compression spring.

12. A wheelchair comprising a seat surface and a leg rest assembly, wherein said leg rest assembly comprises:
a hanger member comprising a hanger portion and a lever;
an elevating member; and
a pivoting member comprising a pivoting point and an arcuate portion, wherein:
said hanger member and said elevating member are attached to said pivoting member;
said lever may is disposed to variably engage and disengage said arcuate portion of said pivoting member;
said pivoting member may be pivoted in a first direction and a second direction such that said elevating member is raised or lowered;
said pivoting member may be freely pivoted in said first direction when the lever is engaged or disengaged from said arcuate portion of said pivoting member; and
said pivoting member may be pivoted in said second direction only when said lever is disengaged from said arcuate portion of said pivoting member.

13. The assembly as claimed in claim 12 wherein said hanger member is attached to said pivoting member at said pivoting point.

14. The assembly as claimed in claim 13 wherein said elevating member is attached to said pivoting member proximate to said arcuate portion of said pivoting member.

15. The assembly as claimed in claim 14 wherein:
said elevating member has an end attached to said pivoting member;
said hanger member has an upper portion attached to said pivoting member;
said end of said elevating member is proximate to said upper portion of said hanger member.

16. The assembly as claimed in claim 15 wherein said hanger member has a lower portion disposed such that said arcuate portion of said pivoting member may pass through said lower portion of said hanger member, and wherein said lever is attached to said lower portion of said hanger member.

17. The assembly as claimed in claim 12 wherein said lever positively engages said arcuate portion of said pivoting member by pressure provided by a compression spring, and wherein said lever may be disengaged from said arcuate portion of said pivoting member by providing pressure to said lever to compress said compression spring.

18. A leg rest assembly such as for a wheel chair, comprising:
an elevating member that can support a leg;
said elevating member being adapted to pivot in a first direction and a second direction such that said elevating member is variably raised or lowered; and
means for enabling the elevating member to freely pivot in a first direction and for selectively preventing pivoting movement of said elevating member in a second direction.
